(19) United States
(12) Patent Application Publication
(10) Pub. No.: US 2006/0109428 A1
(43) Pub. Date: May 25, 2006

(54) Rear projection system

(75) Inventor: Nai-Yueh Liang, Taipei City (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/126,257

(22) Filed: May 11, 2005

(30) Foreign Application Priority Data
Nov. 24, 2004 (TW) 093136214

(51) Int. Cl. G03B 21/14

(52) U.S. Cl. 353/84

(57) ABSTRACT

A rear projection system includes a light source, a light tunnel and a gradient filter layer. In this case, the light source emits a light beam. After being split, the light beam is transmitted into the light tunnel from an incident side and comes out the light tunnel from an emerging side. The gradient filter layer is disposed at the emerging side of the light tunnel. The transmission rate of the central area of the gradient filter layer is smaller than that of the edge area of the gradient filter layer.

### BACKGROUND OF THE INVENTION

1. Field of Invention

The invention relates to a projection system and, in particular, to a rear projection system.

2. Related Art

The image projection system is one of the most popular products in the optoelectronic industry. The most known technologies include the cathode ray tube (CRT) technology, the digital light processing (DLP) technology, the reflective liquid crystal technology, the transmissive liquid crystal technology, and the likes.

Hereinafter, the DLP technology is taken as an example for illustrating the mechanism for generating the image.

The DLP is digitally controlled and is operated with utilizing the light-reflecting principle. The light beam is firstly generated from a light source and then focused with a lens. After that, the light beam passes through a color filter such as including a red filter, a green filter and a blue filter. Next, the light beam achieves a digital micro-mirror device (DMD). The DMD includes a plurality of movable micro-mirrors and driving electrodes for controlling the tilt angle and rotating time of the micro-mirrors. After being reflected with the DMD, the light beam can be projected on a screen through a projection lens for generating an image.

With reference to FIG. 1, in a DLP 10, a light source 11 emits a light beam, which then passes through an UV/IR cut filter 12 and a color wheel 13 for light splitting. After that, the light beam passes through a light tunnel 14 and a relay lens 15, and then reaches the reflective mirror 16. The reflective mirror 16 reflects the light beam to the DMD 17 obliquely. After processed with the DMD 17, the light beam goes to a projection lens 18 and then is projected on a screen 19 for generating the image.

The light tunnel 14 is used to guide the light beam (e.g. to change the progressing direction of the light beam) and to collimate the light beam. In addition, the light tunnel 14 can improve the luminance uniformity and control the aspect ratio of the projected light. The light tunnel 14 is also known as a light rod, an integration rod, a light pipe or a rod lens.

Since the light beam is reflected to the DMD 17 obliquely, the paths of different parts of the reflected light beam from the reflective mirror 16 to the DMD 17 are not equivalent. Thus, the light beam may not be focused on the DMD 17, causing that the area of the light beam reaching one surface of the DMD 17 is increased. As a result, the light reaching the surface of the DMD 17 has reduced brightness and lower luminance uniformity.

In the conventional DLP 10, the DMD 17 includes a control circuit 171 for controlling the tilt angle of each DMD 17 to generate gray-scaled images according the red, blue and green gray signals of the video signals.

However, to generate image with uniform luminance, the control circuit 171 of the DMD 17 must process a pre-compensation of the light beam. This will reduce the gray level that the DMD 17 can provide, so as to affect the final image quality.

It is therefore an important subjective of the invention to provide a rear projection system for solve the problems of non-uniform luminance and reduced gray level caused by the pre-compensation process.

### SUMMARY OF THE INVENTION

In view of the foregoing, the invention is to provide a rear projection system, which has a gradient filter layer for improve the luminance uniformity of images.

To achieve the above, a rear projection system of the invention includes a light source, a light tunnel and a gradient filter layer. In the invention, the light source emits a light beam. After being split, the light beam is transmitted into the light tunnel from an incident side and is emerged out the light tunnel from an emerging side. The gradient filter layer is disposed at the emerging side of the light tunnel. The transmission rate of the central area of the gradient filter layer is smaller than that of the edge area of the gradient filter layer.

As mentioned above, the rear projection system of the invention has a gradient filter layer disposed at the light emerging side of the light tunnel. Comparing to the prior art, the gradient filter layer, which has the transmission rate at the central area smaller than the transmission rate at the edge area, can cause the light beam with non-uniform luminance. Thus, the previously described problem of non-uniform luminance, which has higher luminance at the center and lower luminance in the edges, caused by the different routes of projected light can be improved. Then, the light beam reaching the imager unit can be turned into a light beam with uniform luminance. In the invention, it is unnecessary for the imager unit to process the pre-compensation, so that the gray level, which the imager unit can provide, is increased, resulting in the better final image quality.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional DLP;

FIG. 2 is a schematic view showing a rear projection system according to a first embodiment of the invention, which is applied in a DLP;

FIG. 3 is a schematic view showing a light tunnel and a gradient filter layer of the rear projection system according to a first embodiment of the invention;

FIG. 4 is a schematic view showing another light tunnel and another gradient filter layer of the rear projection system according to the first embodiment of the invention;

FIG. 5 is a schematic view showing still another light tunnel and gradient filter layer of the rear projection system according to the first embodiment of the invention;

FIG. 6 is a schematic view showing the transmission rate of the gradient filter layer according to the first embodiment of the invention; and

FIG. 7 is a schematic view showing a rear projection system according to a second embodiment of the invention, which is applied in a liquid crystal on silicon (LCOS) display.

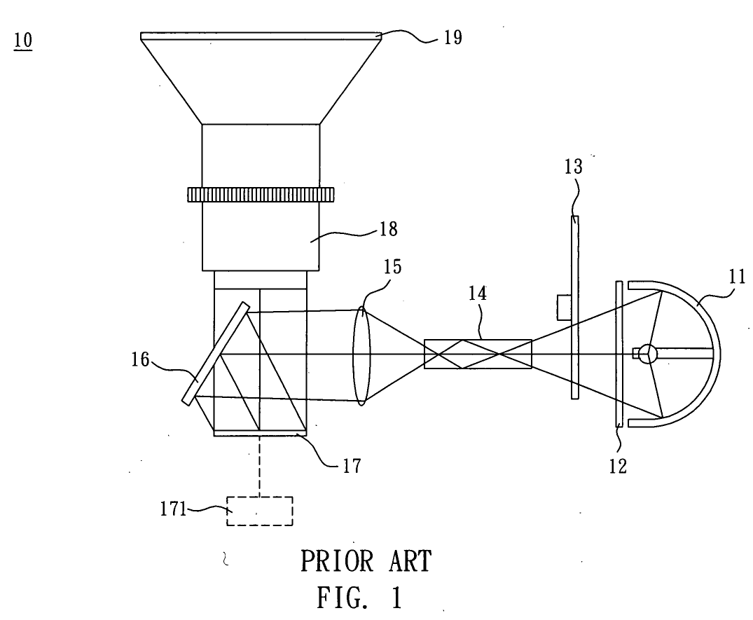

### DETAILED DESCRIPTION OF THE INVENTION

The present invention will be apparent from the following detailed description, which proceeds with reference to the accompanying drawings, wherein the same references relate to the same elements.

### FIRST EMBODIMENT

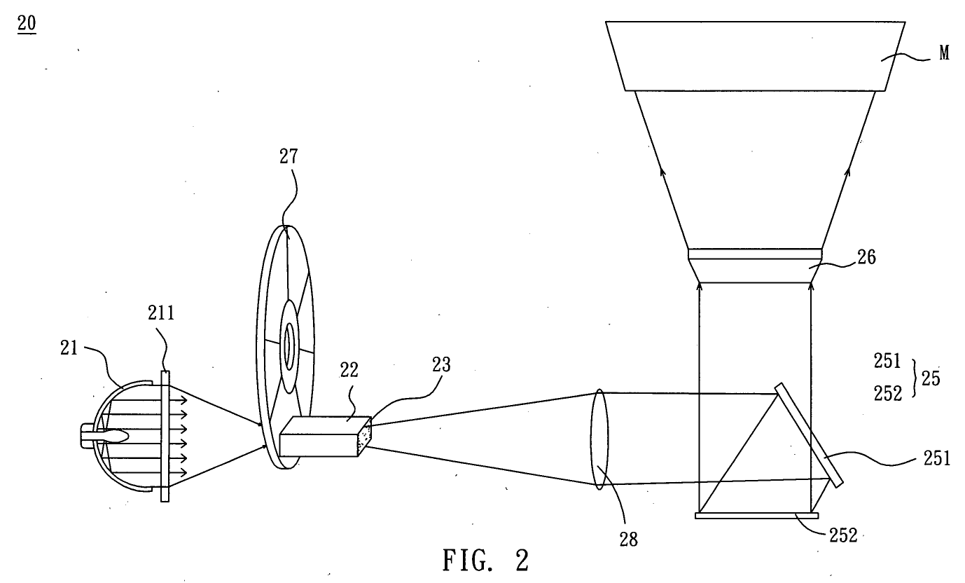

With reference to FIG. 2, a rear projection system 20 according to the first embodiment of the invention includes a light source 21, a light tunnel 22 and a gradient filter layer 23. In the embodiment, the rear projection system 20 is applied in a DLP.

The light source 21 emits a light beam, and is one selected from a lamp, an organic light-emitting diode (OLED), an organic light-emitting diode array (OLED array), a laser, and a laser array. In the current embodiment, an UV/IR cut filter 211 is installed adjacent to the light source 21 for filter off the UV light and IR light in the light beam.

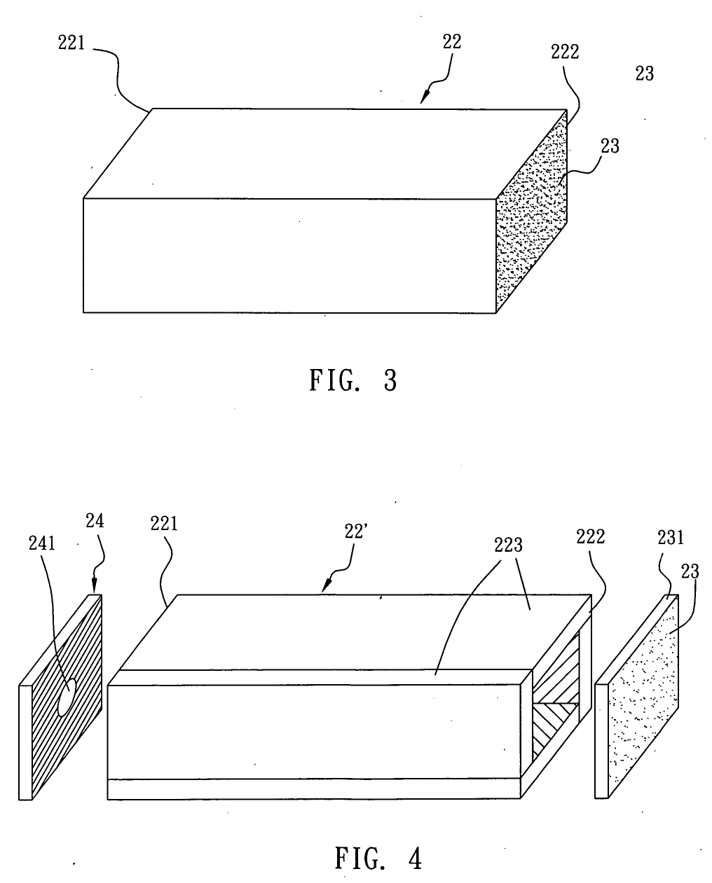

With reference to FIGS. 2 and 3, the light beam is transmitted into the light tunnel 22 from a light incident side 221 and is emerged out of the light tunnel 22 through a light emerging side 222. Herein, the light tunnel 22 is a solid rod such as a solid glass rod, and utilizes the total reflection phenomenon to guide and collimate the light beam. In addition, the outer surface of the light tunnel 22 may has a high-reflective layer. Thus, the light beam incident into the light tunnel 22 can be guided and outputted from the light emerging side 222. Accordingly, the light tunnel 22 can guide and collimate the light beam.

Referring to FIG. 4, the light tunnel, such as the light tunnel 22′, can be composed of a plurality of mirrors 223. In this case, the light tunnel 22′ is a hollow tunnel. The inner surfaces of the light tunnel 22′, which are the surfaces of the mirrors 223 facing to the tunnel for light passing, may have a high-reflective layer (shown as the portion with oblique lines). In the current embodiment, the high-reflective layer can cause total reflection of the light beams incident into the light tunnel 22′. Accordingly, the light tunnel 22′ can guide and collimate the light beam.

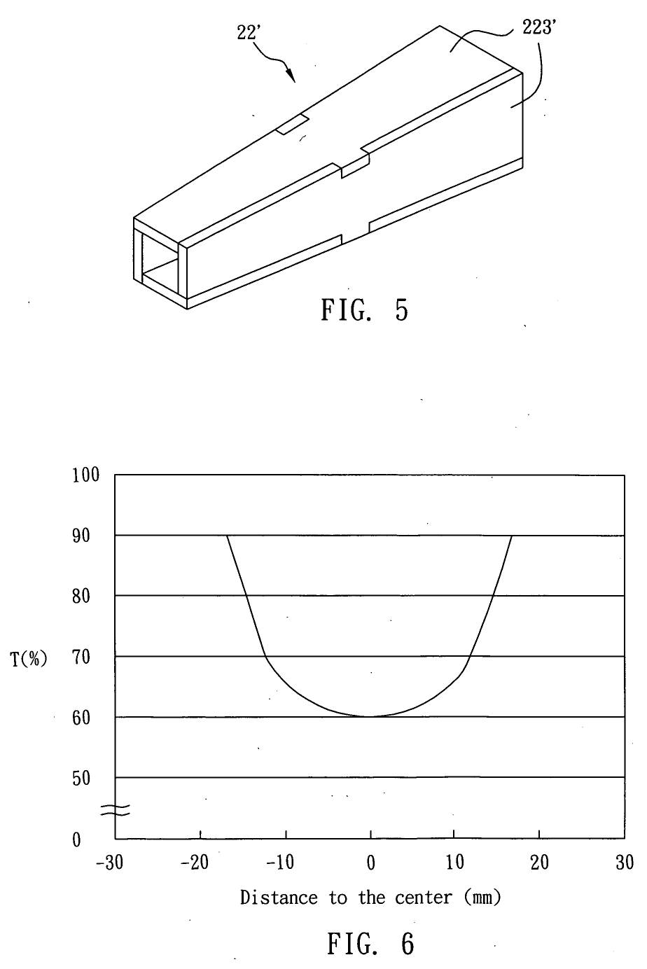

In addition, according to the assembling angle of the mirrors 223, the shapes of the mirrors 223, or the outer shape of the solid rod, the different cross-sections of the light tunnel 22 or 22′ perpendicular to the light passing direction may have equivalent or non-equivalent shapes such as a rectangular, a trapezoid, a parallelogram or other polygons. In the present embodiment, the cross-section of the light tunnel is rectangular, and the cross-section of the light tunnel shown in FIG. 5 is trapezoid.

As shown in FIG. 3, the gradient filter layer 23 is disposed at the light emerging side 222 of the light tunnel 22. Regarding to the light tunnel 22 that is a solid rod, the gradient filter layer 23 can be directly coated on the light tunnel 22.

As shown in FIGS. 3 and 4, the light tunnel 22′ is composed of several mirrors 223 and 223′. In this case, the gradient filter layer 23 is disposed on a transparent substrate 231, and then the transparent substrate 231 is attached to the light emerging side 222 of the light tunnel 22′.

The gradient filter layer 23 can be a metal reflective layer, which is made of, for example, chromium or silver. In addition, the gradient filter layer 23 can be made of a dielectric material. By different thicknesses or densities, the transmission rate at the central area of the gradient filter layer 23 is smaller than the transmission rate at the edge area of the gradient filter layer 23. In other words, the edge area of the gradient filter layer 23 has higher transmission rate.

With reference to FIG. 6, the horizontal axle represents the distance between any point and the center of the gradient filter layer 23, and the vertical axle is the transmission rate (T %) of the regarded point. As shown in FIG. 6, the central area and the edge area of the gradient filter layer 22 have different transmission rates. The transmission rate at the central area is lower, and the transmission rate at the edge area is higher. The higher transmission rate means the higher light flux; otherwise, the lower transmission rate means the lower light flux. The level of the transmission rate can be determined according to the actual products.

With reference to FIG. 4, the rear projection system 20 may further include a reflecting film 24, which is disposed at the light incident side 221 of the light tunnel 22′. The reflecting film 24 has a transmission portion 241, which allows light going into the light tunnel 22′. The transmission portion 241 may be located at the central area of the reflecting film 24. The reflecting film 24 has a reflecting layer for blocking light scattered or reflected from the light incident side 221 and reflecting the light back to the light tunnel body 22′. Thus, the light flux can be increased so as to compensate the image.

With reference to FIG. 2, the rear projection system 20 further includes an imager unit 25, such as a digital micro-mirror device (DMD). The light beam is emerged from the light tunnel 22, passes through the gradient filter layer 23 and the relay lens 28, and is then projected to the imager unit 25. In the embodiment, the imager unit 25 includes a reflective mirror 251 and a DMD 252, which are similar to the previously mentioned reflective mirror 16 and DMD 17. The DMD 252 includes a plurality of movable micro-mirrors and driving electrodes for controlling the tilt angle and rotating time of the micro-mirrors. After being reflected with the reflective mirror 251 and DMD 252, the light beam can be projected on a screen through a projection lens 26 for generating an image M.

As shown in FIG. 2, the rear projection system 20 further includes a color wheel 27, which is disposed between the light source 21 and the light tunnel 22 for splitting the light beam emitted from the light source 21. Of course, the color wheel 27 can be disposed between the gradient filter layer 23 and the imager unit 25 for splitting the light beam emerged from the light tunnel 22. In the current embodiment, the color wheel 27 is disposed between the light source 21 and the light tunnel 22. The color wheel 27 includes several color filters, including a red sector filter, a green sector filter, a blue sector filter, a transparent sector filter, and/or sector filters with other colors. When the color wheel 27 is rotated in a high speed, the light beam passing through the color wheel 27 can be split.

The light beam is emitted from the light source 21, is split with the color wheel 27, passes through the light tunnel 22, and is then emerged from the gradient filter layer 23. Since the transmission rate at the central area of the gradient filter layer 23 is smaller than the transmission rate at the edge area of the gradient filter layer 23, the non-uniform luminance caused by the non-equivalent routes of parts of the light beam can be compensated. Accordingly, after passing through the gradient filter layer 23, the light beam can finally be turned into a light beam with uniform luminance as reaching the imager unit 25. Therefore, it is unnecessary for the imager unit 25 to process the pre-compensation, so that the gray level, which the imager unit 25 can provide, is increased, resulting in the better final image quality.

### SECOND EMBODIMENT

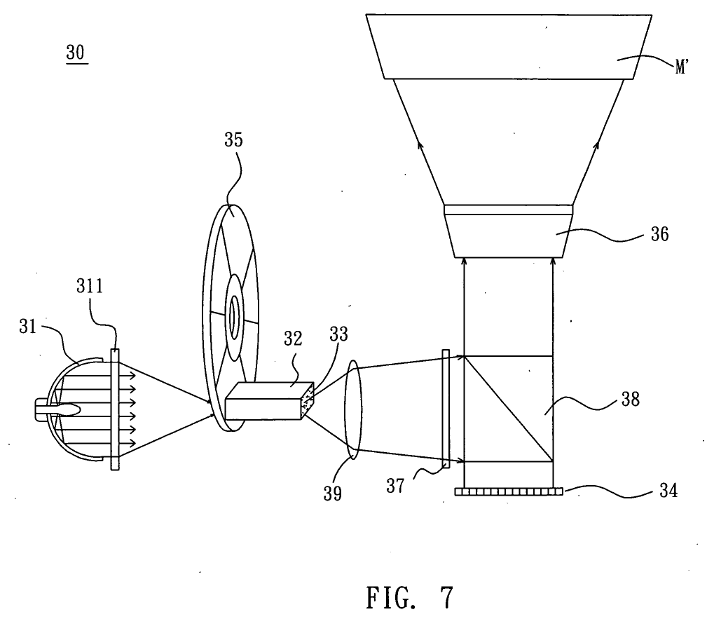

With reference to FIG. 7, a rear projection system 30 according to the second embodiment of the invention includes a light source 31, a light tunnel 32 and a gradient filter layer 33. In the embodiment, the rear projection system 30 is applied in a liquid crystal on silicon (LCOS) display.

The features of the light source 31, light tunnel 32 and gradient filter layer 33 of the second embodiment are the same as those of the light source 21, light tunnel 22 and gradient filter layer 23 of the first embodiment, so the detailed descriptions are omitted for concise purpose.

As shown in FIG. 7, the rear projection system 30 further includes an imager unit 34, such as a liquid crystal on silicon (LCoS) panel. The light beam is emerged from the light tunnel 32, passes through the gradient filter layer 33, and is then projected to the imager unit 34. In the embodiment, the LCoS panel includes two substrates, several spacers distributed between the substrates, and a liquid crystal material filled between the substrates. The LcoS panel further includes a circuit for controlling the rotations of the molecular of the liquid crystal material so as to determine the amount of light capable of passing through the panel.

As shown in FIG. 7, the rear projection system 30 further includes a color wheel 35 and a projection lens 36. The features of the color wheel 35 and a projection lens 36 of the second embodiment are the same as those of the color wheel 27 and a projection lens 26 of the first embodiment, so the detailed descriptions are omitted for concise purpose.

In addition, the rear projection system 30 further includes a relay lens 39, a polarizer unit 37 and a prism unit 38. The relay lens 39 and the polarizer unit 37 are disposed between the gradient filter layer 33 and the imager unit 34. Thus, the light beam passing through the relay lens 39 and the polarizer unit 37 in sequence can be turned into a polarized light beam, which is then incident into the imager unit 34. The light beam emerged from the imager unit 34 is then entered into the prism unit 38 and passes through the projection lens 36 for generating the image M′.

The light beam is emitted from the light source 31, is split with the color wheel 35, passes through the light tunnel 32, and is then emerged from the gradient filter layer 33. Since the transmission rate at the central area of the gradient filter layer 33 is smaller than the transmission rate at the edge area of the gradient filter layer 33, the non-uniform luminance caused by the non-equivalent routes of parts of the light beam can be compensated. Accordingly, after passing through the gradient filter layer 33, the light beam can finally be turned into a light beam with uniform luminance as reaching the imager unit 34. Therefore, it is unnecessary for the imager unit 34 to process the pre-compensation, so that the gray level, which the imager unit 34 can provide, is increased, resulting in the better final image quality.

In summary, the rear projection system of the invention has a gradient filter layer disposed at the light emerging side of the light tunnel. Comparing to the prior art, the gradient filter layer, which has the transmission rate at the central area smaller than the transmission rate at the edge area, can cause the light beam with non-uniform luminance. Thus, the previously described problem of non-uniform luminance, which has higher luminance at the center and lower luminance in the edges, caused by the different routes of projected light can be improved. Then, the light beam reaching the imager unit can be turned into a light beam with uniform luminance. In the invention, it is unnecessary for the imager unit to process the pre-compensation, so that the gray level, which the imager unit can provide, is increased, resulting in the better final image quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A rear projection system, comprising:
a light source, which emits a light beam;
a light tunnel, which has a light incident side and a light emerging side, wherein the light beam is transmitted into the light tunnel from the light incident side and is emerged out of the light tunnel through the light emerging side; and
a gradient filter layer, which is disposed at the emerging side of the light tunnel, wherein a transmission rate of a central area of the gradient filter layer is smaller than a transmission rate of an edge area of the gradient filter layer.

2. The rear projection system of claim 1, wherein the light source is at least one selected from a lamp, an organic light-emitting diode, an organic light-emitting diode array, a laser, and a laser array.

3. The rear projection system of claim 1, wherein the light tunnel is a solid rod.

4. The rear projection system of claim 1, wherein the gradient filter layer is coated on the light emerging side of the light tunnel.

5. The rear projection system of claim 1, wherein the gradient filter layer is made of one selected from a metal and a dielectric material.

6. The rear projection system of claim 1, further comprising:
a reflecting film, which is disposed at the light incident side of the light tunnel and has a transmission portion.

7. The rear projection system of claim 1, wherein the light tunnel is composed of a plurality of mirrors.

8. The rear projection system of claim 7, further comprising:
a transparent substrate, wherein the gradient filter layer is disposed on the transparent substrate and the transparent substrate is attached to the light emerging side of the light tunnel.

9. The rear projection system of claim 1, further comprising:
an imager unit, wherein the light beam is emerged from the light tunnel, passes through the gradient filter layer, and is projected on the imager unit to form an image.

10. The rear projection system of claim 1, further comprising:
a color wheel, which is disposed between the light source and the light tunnel for splitting the light beam emitted from the light source.

11. The rear projection system of claim 9, further comprising:
a color wheel, which is disposed between the gradient filter layer and the imager unit for splitting the light beam.

12. The rear projection system of claim 9, wherein the imager unit is a digital micro-mirror device (DMD).

13. The rear projection system of claim 9, wherein the imager unit is a liquid crystal on silicon (LCoS) panel.

14. The rear projection system of claim 9, further comprising:
a polarizer unit, which is disposed between the gradient filter layer and the imager unit for turning the light beam into a polarized light beam.

15. The rear projection system of claim 9, further comprising:
a prism unit, wherein the light beam outputted from the imager unit is inputted into the prism unit for generating the image.
